(19) United States
(12) Patent Application Publication
(10) Pub. No.: US 2019/0317650 A1
(43) Pub. Date: Oct. 17, 2019

(54) METHODS AND SYSTEMS FOR PROVIDING ON-SCREEN TECHNICAL SHEETS DURING NON-DESTRUCTIVE TESTING (NDT)

(71) Applicant: Illinois Tool Works Inc., Glenview, IL (US)

(72) Inventors: Sakif Bin Ferdous, Skokie, IL (US); Wyatt M. Burns, Woodridge, IL (US); Justin J. Stewart, DeWitt, IA (US); Emily Newhouse, Chicago, IL (US)

(21) Appl. No.: 16/387,094

(22) Filed: Apr. 17, 2019

Related U.S. Application Data
(60) Provisional application No. 62/659,002, filed on Apr. 17, 2018.

(51) Int. Cl. G06F 3/0483; G06F 3/0484; G01N 15/08; G01N 27/72

(52) U.S. Cl. CPC G06F 3/0483; G01N 27/72; G01N 15/082; G06F 3/04847

(57) ABSTRACT

Systems and methods are provided for on-screen technical sheets. An non-destructive testing (NDT) based setup may be configured for selecting based on a particular non-destructive testing (NDT) inspection and/or article being inspected, a corresponding technical sheet; and for providing to a user via an interactive component of the NDT setup, during the NDT inspection, the selected technical sheet or information generated based on the selected technical sheet, such that the user is enable to continue performing the NDT inspection and to remain in proximity of the setup where the NDT inspection is conducted.

### CLAIM OF PRIORITY

This patent application claims priority to and benefit from U.S. Provisional Patent Application Ser. No. 62/659,002, filed on Apr. 17, 2018. The above identified application is hereby incorporated herein by reference in its entirety.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

In some instances, dedicated material and/or products may be used in non-destructive testing. For example, non-destructive testing of particular type of articles may entail applying (e.g., by spraying on, pouring into, passing through, etc.), to the would-be tested article or part, a material that is configured for performing the non-destructive testing. In this regard, such material (referred to hereinafter as “NDT material”) would have particular characteristics (e.g., magnetic, visual, etc.) suitable for the non-destructive testing'e.g., characteristics that would allow or enhance detection of defects, irregularities, and/or imperfections (referred to collectively hereinafter as “defects”) in the article during non-destructive testing (NDT) based inspections.

The non-destructive testing (NDT) based inspections may be conducted in different manner—with respect to many by which defects may be detected. For example, in some instances, the NDT based inspections are conducted visually—that is, where the detection of defects is done by visually inspecting the inspected articles. This may be particular allowed or enhance by used of NDT material. In this regard, the application of NDT material may allow or enhance visual NDT based inspections, such as by making the defects more easily detected based on the particular characteristics of NDT material. For example, the defects may be visually identified based on, e.g., color contrast or some light-related behavior.

In some instances, ambient light may be used in such visual inspections—that is, the users may simply visually inspect the article in a well-lit area, such as after application of the NDT material. Alternatively or additionally, a light source (e.g., a special lamp) may be used within the system or setup being used to conduct the NDT inspection. In this regard, such light source may provide light that meets particular criteria for conducting the inspections.

Conventional approaches for conducting non-destructive testing (NDT) have some limitations, however. For example, conducting NDT based inspections may be complicated by variations in articles being inspected, requirements of different types of inspections, and inspection conditions, and/or complexity in NDT machines or setups, which conventional approaches may fail to account for that, or do so sufficiently.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to product testing and inspection. More specifically, various implementations in accordance with the present disclosure are directed to methods and systems for on-screen technical sheets, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example non-destructive testing (NDT) inspection setup, which may be configured for operation in accordance with the present disclosure.

FIG. 2 illustrates an example controller for use in non-destructive testing (NDT) based setups supporting on-screen technical sheets, in accordance with aspects of the present disclosure.

FIGS. 3A-3C illustrate an example use scenario of on-screen technical sheets, in accordance with aspects of the present disclosure.

### DETAILED DESCRIPTION

Various implementations in accordance with the present disclosure are directed to providing enhanced and optimized non-destructive testing (NDT) inspections, particularly by implementing and operating non-destructive testing (NDT) setups that support on-screen technical sheets. In this regard, as noted above, conventional solutions for conducting non-destructive testing (NDT) have some limitations, particularly due to variations in articles being inspected, requirements of different types of inspections, and inspection conditions, and/or complexity in NDT machines or setups. This may be particularly challenging when users may be not sufficiently experienced to handle such complexities, and/or to appreciate or know how to account for such variations. Therefore, NDT setups or systems that overcome at least some of these challenges may be desirable.

Accordingly, implementations based on the present disclosure address such limitations and challenges, such as by providing non-destructive testing (NDT) based setups that support use of technical sheets, with these NDT setups being configured for storing, generating, and/or updating dedicated technical sheets (e.g., for particular articles and/or inspections) that may be used to provide operators with information for assisting them in conducting the inspections.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein, an “inspection component” includes any component of an apparatus, a machine, and/or a setup configured for performing or facilitating non-destructive testing (NDT) inspection of articles. For example, an “inspection component” may include any one of: a structure or frame element (e.g., of the apparatus or the machine, or the setup as a whole), a holder component configured to hold the article being inspected (and, optionally, to position it in a particular manner for conducting the inspection), a triggering component configured to trigger or otherwise cause a particular effect or characteristics in the article (e.g., magnetization component configured for magnetizing the article, in magnetization based inspection), an application component configured for applying non-destructive testing (NDT) material to the article (e.g., in penetrant based inspection), a light source configured to emit light during the inspection, and the like. In some instances, inspection components may originate or otherwise be obtained from different sources (e.g., different manufacturers), and may be combined together—e.g., when constructing an inspection setup.

As utilized herein, a “technical sheet” may comprise information pertinent to performing NDT inspection of a particular article or part—e.g., information relating to particular part (or article), including description of the part, the product that includes the part, technical characteristics of the part, etc., as well as information relating to conducting inspection in accordance with particular technique or methodology, as tailored for the part (e.g., values for applicable parameters or settings). The technical sheet may be configured based on a predefined data structure, for maintaining such information, particularly for storage and use in particular machines or systems that are used in conjunction with NDT inspections (e.g., being incorporated into NDT setups). An example of technical sheets is the “technique sheets” as commonly used in the industry.

As utilized herein, a “remote system” includes any system that is not within or in close proximity to a non-destructive testing (NDT) setup. Thus a remote system may include both true remote systems (e.g., systems that are external to a physical space where the NDT setup is located) as well as “localized” remote systems—that is, systems that are within the same physical space where the NDT setup is located, but are not part of the NDT setup.

An example system for non-destructive testing (NDT), in accordance with the present disclosure, may comprise one or more inspection components configured to apply non-destructive testing (NDT) inspection to an article; an interactive component configured to handle interactions with a user of the system during the non-destructive testing (NDT) inspection; and one or more circuits configured to select based on search criteria associated with the non-destructive testing (NDT) inspection and/or the article, a corresponding technical sheet, comprising information relating to the article and/or the non-destructive testing (NDT) inspection; and provide to the user via the interactive component, during the non-destructive testing (NDT) inspection, the selected technical sheet or information generated based on the selected technical sheet, such that the user may be enable to continue performing the non-destructive testing (NDT) inspection and to remain in proximity of the system.

In an example implementation, the one or more circuits may be configured to store one or more technical sheets and/or preprogramed data for use in generating technical sheets.

In an example implementation, the one or more circuits may be configured to generate at least a portion of the selected technical sheet based on the one or more stored technical sheets and/or the preprogramed data used in generating technical sheets.

In an example implementation, the one or more circuits may be configured to update at least one of the one or more stored technical sheets and/or the preprogramed data used in generating technical sheets.

In an example implementation, the one or more circuits may be configured to obtain at least a portion of the technical sheet from a remote system.

In an example implementation, the system may comprise a communication component configured to setup a connection with the remote system.

In an example implementation, the interactive component may be configured as a human machine interface (HMI) based component.

In an example implementation, the interactive component may comprise a visual output device. The visual output device may comprise a display or a screen.

In an example implementation, the one or more circuits may be configured to generate a visual representation of the selected technical sheet, for display via the visual output device.

In an example implementation, the one or more circuits may be configured to provide the selected technical sheet visually to the user of the system via the visual output device.

In an example implementation, the system may comprise an input component configured to receive input from the user of the system during the non-destructive testing (NDT) inspection.

In an example implementation, the one or more circuits may be configured to select the technical sheet based on user input received via the input component.

In an example implementation, the one or more circuits may be configured to handle user input received via the input component, the user input relating to the selected technical sheet and/or information provided via the selected technical sheet.

In an example implementation, the one or more circuits may be configured to set one or more parameters associated with at least one of the one or more inspection components based on the selected technical sheet.

In an example implementation, the one or more inspection components may be configured for performing magnetic particle inspection (MPI) based inspections.

In an example implementation, the one or more inspection components may be configured for performing liquid penetrant inspection (MPI) based inspections.

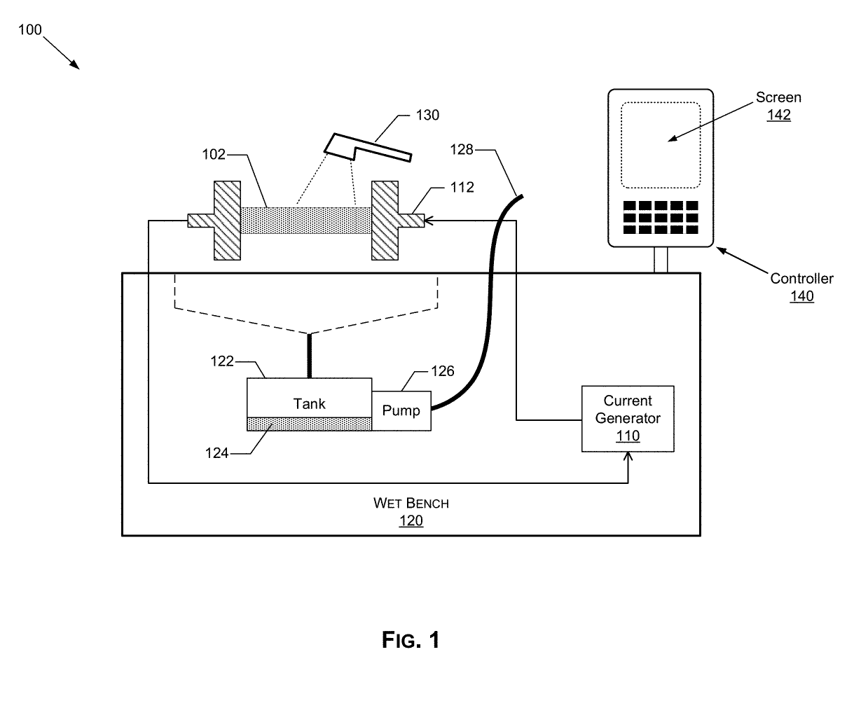

FIG. 1 illustrates an example non-destructive testing (NDT) inspection setup, which may be configured for operation in accordance with the present disclosure. Shown in FIG. 1 is an NDT setup 100 which may be used in performing NDT inspections.

The NDT setup 100 may comprise various components configured for performing non-destructive testing (NDT) inspection of articles (e.g., machine parts and the like), such as in accordance with particular NDT inspection methodology and/or technique. In this regard, the goal with any NDT inspection technique is to make defects in inspected article detectable during the inspection, and to do so without damaging or otherwise altering the inspected article. Various NDT inspections techniques may be used. Two example techniques are “magnetic particle inspection” (MPI) technique and the “liquid penetrant inspection” (LPI) technique, with the MPI technique typically being used with ferrous material, and the LPI technique typically being used with non-ferrous material (e.g., aluminum, brass, etc.).

As noted, the goal with any NDT inspection is making defects detectable. In this regard, various forms of detections may be used or supported in NDT inspections. For example, the inspection and accordingly the detection of defects may be done visually. In this regard, with visual NDT inspections, articles may be inspected, and defects therein may be detected visually—e.g., using ambient light and/or light sources (e.g., a lamp) incorporated into the NDT setups. Such light sources may be configured to emit light in particular manner. For example, light sources used in NDT setups may be designed and/or configured to emit white light, a light of other type (e.g., ultraviolet (UV) light), or any combination thereof.

In some instances, NDT setups (e.g., the NDT setup 100) may incorporate special measures for optimizing inspection environment. For example, in NDT setups configured for visual or light based inspections, an inspection enclosure may be used to ensure a suitable lighting environment, such as by blocking or otherwise limiting ambient light. This may be done to allowing controlled the lighting environment for the inspection, by ensuring that there is no light within the area where the inspection takes place, or that all or most of the light within the area where the inspection takes place originates from light sources of the NDT setups. Such inspection enclosure may be configured, for example, as a tent-like structure or any other structure that provide sufficient shading.

In some instances, NDT inspections may entail use of NDT material, which may be applied to the inspected articles, such as to facilitate or enhance detectability of the defects. In this regard, the NDT material may be selected or configured to cause or enhance identification of defects, such as based on particular exhibited behavior or characteristics in the article (particularly at areas where the defects are), in response to the application of the NDT material, and (optionally) another trigger—e.g., magnetization.

For example, with visual NDT inspections, the NDT material may be selected or configured to enable or enhance visual identification of defects, such as based on particular visual behavior—e.g., color contrast or some other light-related behavior. Various techniques or approaches may be used for the application of the NDT material to the inspect articles. One example approach is wet bench based setups. In this regard, in wet bench based setups the inspected articles are “bathed” using an NDT material—that is, the NDT material is applied to the inspected articles (e.g., using a hose-based system), before and/or during the inspection, to facilitate the detection of defects in the articles.

In some instances, the NDT inspections may entail use of a particular trigger for causing or enhancing detection of the defects, alone in combination with something else (e.g., NDT material applied to the inspected article). One example trigger that may be used during NDT inspections is magnetization, specifically when inspecting articles composed of or comprising ferrous material. In this regard, defects in such articles may be detected (e.g., visually) based on particular exhibited behavior or characteristics in response to magnetization to the articles, with the exhibited behavior or characteristics being rendered more detectable in some instances by application of NDT material to the articles. The magnetization may be achieved, for example, by application of electrical current through the article, magnetic induction (e.g., using handheld magnetization equipment), etc.

For example, as shown in FIG. 1, the NDT setup 100 may be a wet bench based setup configured for magnetic particle based inspections. In this regard, as shown in the example implementation illustrated in FIG. 1, the NDT setup 100 may include a wet bench 120, comprising a tank 122 that stores an NDT solution 124, which may be applied onto inspected articles (e.g., the article 102 as shown in FIG. 1), via a pump 126 and a hose 128. The NDT setup 100 of FIG. 1 also includes a current generator 110 that applies electrical current(s) to a to-be inspected article (e.g., part) 102 via electrical contacts 112. In this regard, various magnetization approaches may be used, with some systems allowing for selecting among such options.

The magnetization may be achieved using, for example, AC (alternating current), half wave DC (direct current), or full wave DC (direct current). In some systems, a demagnetization function may be built into the system. For example, the demagnetization function may utilize a coil and decaying AC (alternating current).

During inspection, the NDT material 124 (e.g., a wet magnetic particle solution) is applied to the part. The particle solution 124 (also called “bath”) may comprise visible or fluorescent particles that may be magnetized. The particle solution 124 may be collected and held in the tank 122. The pump 126 pumps the bath through a hose 128 to apply the particle solution 124 to the part 102 being inspected (e.g., via a nozzle 130 that is used in spraying the parts) and/or to collect samples of the particle solution 124 (e.g., in a container (not shown) for contamination analysis).

The NDT setup 100 may also incorporate a controller unit 140, configured for providing control related functions in the NDT setup 100, such as to control other components, to allow users to control the NDT setup 100 and/or inspections performed therein, etc. In this regard, the controller unit 140 may comprise suitable circuitry and input/output components (e.g., screen(s), speaker(s), keypad, etc.).

For example, the controller unit 140 may comprise suitable circuitry for generating control data applied to components of the NDT setup 100, for processing data generated during the NDT inspections (e.g., status data form components, data relating to inspected articles, etc.), for performing and/or controlling actions taken during NDT inspections, and the like. The disclosure is not so limited, however, and as such other combinations or variations may be supported. For example, the “controller” (or a portion thereof) may comprise or correspond to circuitry already included in the setup (e.g., circuitry in any light sources), which may be configured to performed some at least some of the functions attributed to the controller unit 140.

The controller 140 may incorporate a screen or display 142, which may be used to display information relating to NDT inspections performed in accordance with the present discloser. The disclosure is not so limited, however, and in some instances, the screen 142 (including minimal required circuitry) and the controller unit 140 may be implemented as separate components.

In an example implementation, the controller unit 140 may be configured to operate as a human machine interface (HMI) based unit, providing and/or supporting HMI based interactions with the user—e.g., via the display 142 and/or any other available input/output (I/O) devices within the controller 140 and/or the NDT setup 100 as a whole.

The NDT setup 100 may be configured, in accordance with the present disclosure, for supporting on-screen technical sheets during non-destructive testing (NDT). For example, when the NDT setup 100 is being used to perform a particular NDT inspection on particular article, a technical sheet may be selected (e.g., via the controller unit 140) based on search criteria associated with the non-destructive testing (NDT) inspection and/or the article. In this regard, as noted above, the technical sheet may be configured adaptively and uniquely for the article (or a type of articles corresponding to the article), and for the inspection being performed on that article. For example, the technical sheet may comprise information relating to the article, including description of the article, a product that includes the article, technical characteristics of the article, etc., as well as information relating to conducting inspection of the article in accordance with particular technique or methodology, tailored specifically for the article (e.g., values for applicable parameters or settings).

The selected technical sheet (and/or information based thereon) may then be provided to the operator, such as while performing inspection of the article—e.g., during preparation/setup stage, while conducting the inspection, and/or after completing the inspection (such as while assessing its outcome). The technical sheet or information based thereon may be provided via suitable output means in the NDT setup. For example, the technical sheet and/or information based thereon may be presented visually, such as via the screen 142. In this regard, the controller unit 140 may process the technical sheet for presentation to the operator via the screen 142. For example, the controller unit 140 may generate a visual representation of the selected technical sheet, for display via the screen 142.

In some implementations, the controller unit 140 controller unit 140 may set or adjusting parameters, settings, etc. associated component(s) in the NDT setup 100 based on the selected technical sheet.

In some implementations, handling or using technical sheets may be based on user input. For example, the controller unit 140 may be configured to receive user input provided via suitable input means in the NDT setup 100 (e.g., keyboard, keypad, etc.) that is pertinent to handling of technical sheets. The user input may be directed or pertinent to the selection of particular technical sheet, for example, and as such the controller unit 140 may select the technical sheet based on user input received via the input component. The controller unit 140 may also handle user input relating to the selected technical sheet and/or information provided via the selected technical sheet—e.g., adjusting settings or parameters based on the user input.

In some implementations, the controller unit 140 may adaptively generate or modify at least a portion of a selected technical sheet(s). For example, the controller unit 140 may be generate or modify the portion of the selected technical sheet based on (other) stored technical sheets, preprogramed data used in generating technical sheets, user input, etc.

In some implementations, the controller unit 140 may obtain at least a portion of a selected technical sheet, or information needed for generating that portion of the selected technical sheet, from a remote system. In this regard, the controller unit 140 may establish connection(s) (wired and/or wireless) to the remote system, for obtaining the selected technical sheet (or portions or information pertaining thereto) from that remote system. As noted above, the remote system may actually be a localized remote system—e.g., a centralized data server within space that houses one or more NDT setups.

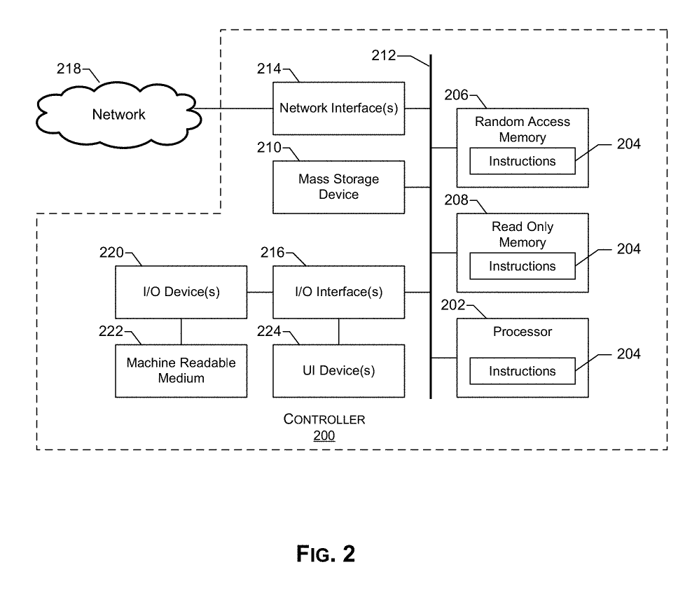

FIG. 2 illustrates an example controller for use in non-destructive testing (NDT) based setups supporting on-screen technical sheets, in accordance with aspects of the present disclosure. Shown in FIG. 2 is a controller system 200.

The controller system 200 may comprise suitable circuitry for implementing various aspects of the present disclosure, particularly for use in providing controller related functions in NDT setups implemented in accordance with the present disclosure. In this regard, the controller system 200 may represent an example implementation of the controller unit 140 of FIG. 1. Accordingly, the controller system 200 may be configured to support on-screen technical sheets, as described with respect to FIG. 1. For example, the controller system 200 may be configured for performing at least some of the functions associated with facilitating generating, outputting (e.g., displaying), modifying, and/or maintaining technical sheets, as described with respect to the NDT setup 100, and particularly the controller unit 140 thereof.

As shown in FIG. 2, the controller system 200 may include a processor 202. In this regard, the example processor 202 may be any general purpose central processing unit (CPU) from any manufacturer. In some example implementations, however, the processor 202 may include one or more specialized processing units, such as RISC processors with an ARM core, graphic processing units, digital signal processors, and/or system-on-chips (SoC).

The processor 202 executes machine readable instructions 204 that may be stored locally at the processor (e.g., in an included cache or SoC), in a random access memory (RAM) 206 (or other volatile memory), in a read only memory (ROM) 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output (I/O) interface 216.

The example network interface 214 includes hardware, firmware, and/or software to connect the controller system 200 to a communications network 218 such as the Internet. For example, the network interface 214 may include IEEE 202.X-compliant wireless and/or wired communications hardware for transmitting and/or receiving communications.

The example I/O interface 216 of FIG. 2 includes hardware, firmware, and/or software to connect one or more user interface devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface.

The example controller system 200 includes a user interface device 224 coupled to the I/O interface 216. The user interface device 224 may include one or more of a keyboard, a keypad, a physical button, a mouse, a trackball, a pointing device, a microphone, an audio speaker, an optical media drive, a multi-touch touch screen, a gesture recognition interface, and/or any other type or combination of types of input and/or output device(s). While the examples herein refer to a user interface device 224, these examples may include any number of input and/or output devices as a single user interface device 224. Other example I/O device(s) 220 an optical media drive, a magnetic media drive, peripheral devices (e.g., scanners, printers, etc.), and/or any other type of input and/or output device.

The example controller system 200 may access a non-transitory machine readable medium 222 via the I/O interface 216 and/or the I/O device(s) 220. Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

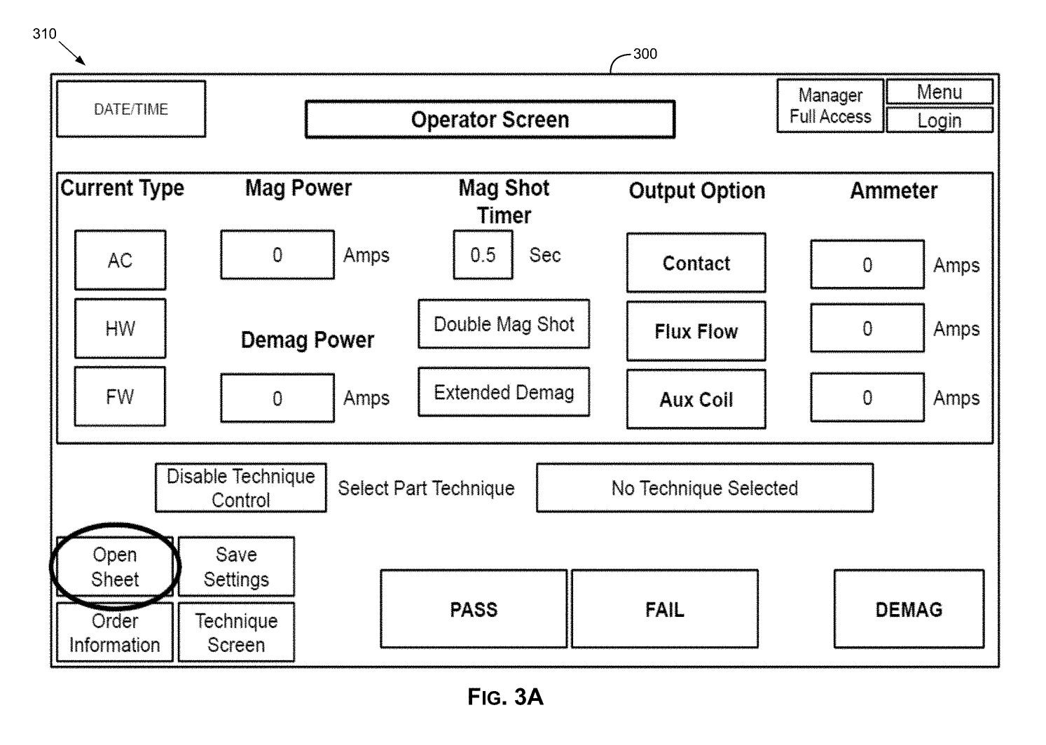

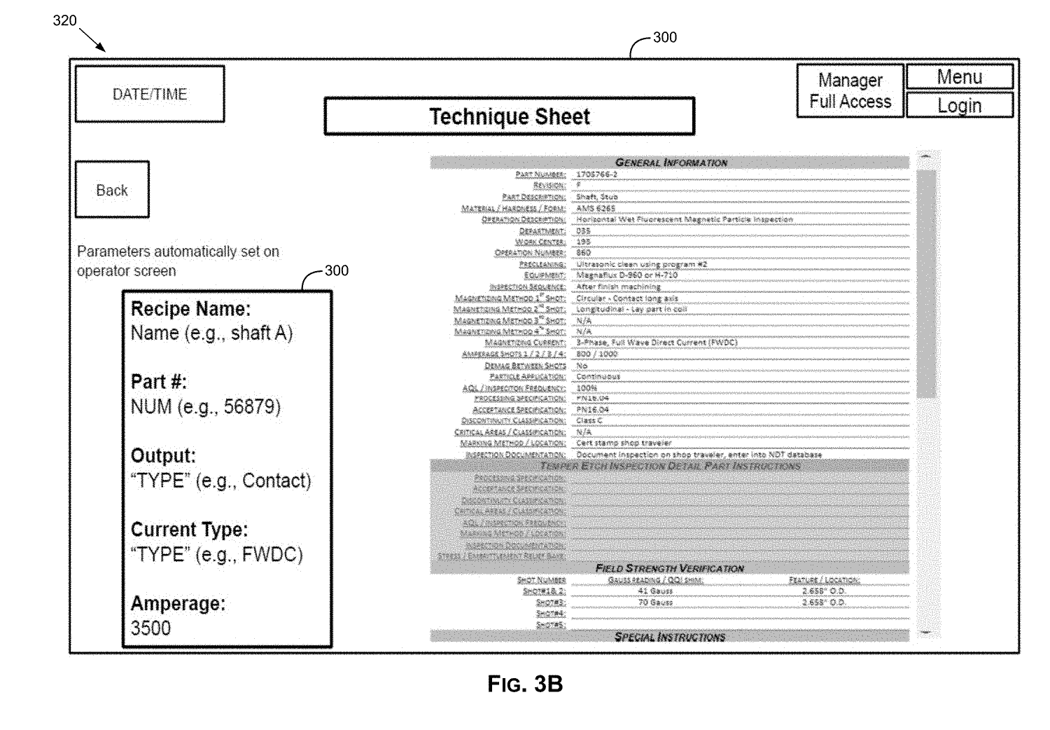

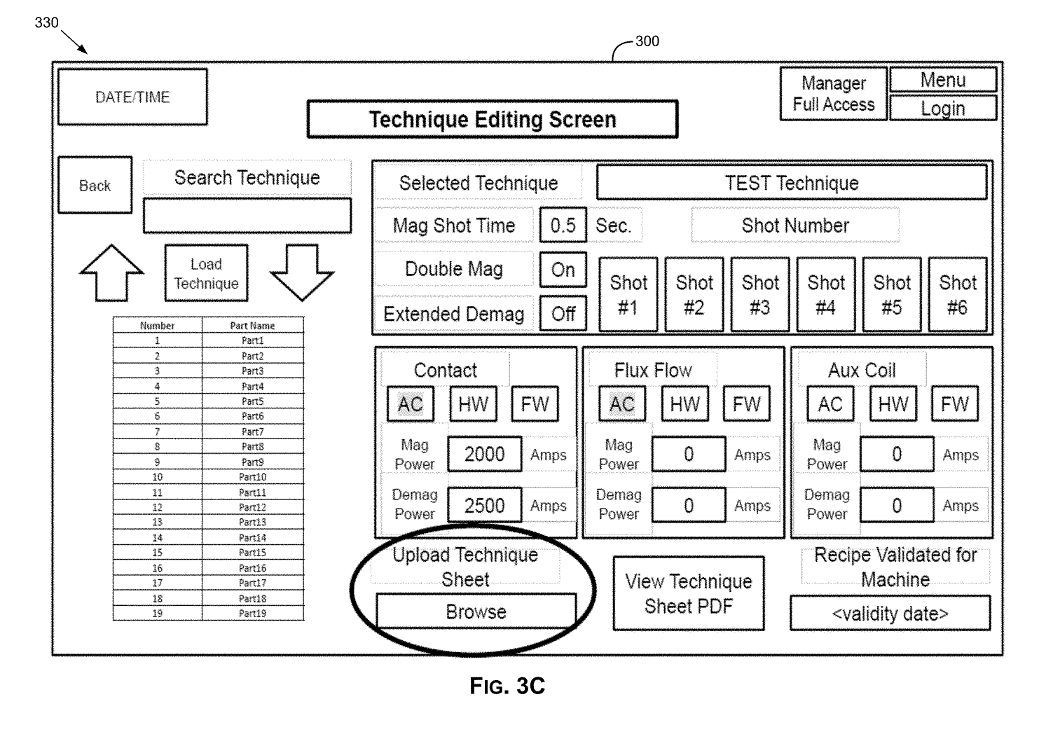

FIGS. 3A-3C illustrate an example use scenario of on-screen technical sheets, in accordance with aspects of the present disclosure. Shown in FIGS. 3A-3B are different screenshots corresponding to an interface 300 presented to an operator of a non-destructive testing (NDT) setup—e.g., via screen 142 of controller unit 140 of the NDT setup 100 of FIG. 1. In particular, the screenshots shown in FIGS. 3A-3C illustrated use scenario in which technical sheets may be selected, displayed, and edited.

Illustrated in FIG. 3A is screenshot 310 of interface 300 during NDT inspection via the NDT setup. In this regard, as shown in FIG. 3A, the screenshot 310 may correspond to the interface 300 during particular stage of the inspection—e.g., while preparing the NDT setup and/or the article for inspection, while conducting the inspection, etc. For example, the screenshot 310 may correspond to normal “operator screen” mode of the interface 300, which may be presented to the operator throughout the inspection, such as a default screen or mode of the interface 300, to help provide output or feedback to the operator and/or receive input therefrom.

For example, in the “operator screen” of the interface 300 may comprise various fields, some of which are only “output” fields—that is, fields showing values for particular parameters or configuration options pertinent to the inspections; other fields may be “input” or “interactive” fields—that is, fields that the operator may use to provide input. In this regard, supported input may comprise mere selection—that is, the field may only supporting selecting between two or more options; alternatively, the user may be able to provide more controlled input—e.g., where the operator may enter more detailed input (e.g., numerical value, text, etc.). This may be done by any suitable means—e.g., using available physical keyboard and/or keypad, by opening virtual keyboard and/or keypad, etc. As shown in FIG. 3A, the “operator screen” may comprise, a “open sheet” field or button (circled) for opening a technical sheet. If that button is selected (e.g., when the operator presses the button), a “technical screen” may be opened, as shown in FIG. 3B.

Illustrated in FIG. 3B is screenshot 320 of interface 300 during NDT inspection via the NDT setup, corresponding to “technique sheet” mode of the interface 300—that is, corresponding displaying of a technical sheet via the interface 300, such as in response to selecting or otherwise activating the “open sheet” field in the “operator screen” as shown in screenshot 310. In the “technique sheet” mode the interface 300 may be configured to present information obtained based on a particular technical sheet. In this regard, the technical sheet may be selected based on the information relating to the article (or part) being inspected, the inspection being conducted, inspection specific conditions or parameters, etc. Information facilitating such selection (e.g., specifying the article (or part), type of inspection, pertinent inspection condition or parameters) may be obtained based on previously provided input by the operator (such as during initial setup of the inspection). Alternatively, the operator may be prompted to provide such information within the “technique sheet” mode, to enable obtaining information required for selecting the suitable technical sheet.

Illustrated in FIG. 3C is screenshot 330 of interface 300 during NDT inspection via the NDT setup, corresponding to “technique editing screen” mode of the interface 300—that is, corresponding displaying of an editing via the interface 300 for allowing the operator to edit particular technical sheets, such as in response to selecting or otherwise activating a particular field (not shown) in the “operator screen” or the “technique sheet”. In the “technique editing screen” mode the interface 300 may be configured to present to the operator fields for allowing selection of particular technical sheet, and once selected, fields for editing (e.g., setting or adjusting) information, parameters, etc. of the selected technical sheet.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A system for use in non-destructive testing (NDT), the system comprising:
one or more inspection components configured to apply non-destructive testing (NDT) inspection to an article;
an interactive component configured to handle interactions with a user of the system during the non-destructive testing (NDT) inspection; and
one or more circuits configured to:
select based on search criteria associated with the non-destructive testing (NDT) inspection and/or the article, a corresponding technical sheet, wherein the technical sheet comprises information relating to the article and/or the non-destructive testing (NDT) inspection; and
provide to the user via the interactive component, during the non-destructive testing (NDT) inspection, the selected technical sheet or information generated based on the selected technical sheet, such that the user is enable to continue performing the non-destructive testing (NDT) inspection and to remain in proximity of the system.

2. The system of claim 1, wherein the one or more circuits are configured to store one or more technical sheets and/or preprogramed data for use in generating technical sheets.

3. The system of claim 2, wherein the one or more circuits are configured to generate at least a portion of the selected technical sheet based on the one or more stored technical sheets and/or the preprogramed data used in generating technical sheets.

4. The system of claim 2, wherein the one or more circuits are configured to update at least one of the one or more stored technical sheets and/or the preprogramed data used in generating technical sheets.

5. The system of claim 1, wherein the one or more circuits are configured to obtain at least a portion of the technical sheet from a remote system.

6. The system of claim 5, comprising a communication component configured to setup a connection with the remote system.

7. The system of claim 1, wherein the interactive component is configured as a human machine interface (HMI) based device.

8. The system of claim 1, wherein the interactive component comprises a visual output device.

9. The system of claim 8, wherein the visual output device comprises a display or a screen.

10. The system of claim 8, wherein the one or more circuits are configured to generate a visual representation of the selected technical sheet, for presentation via the visual output device.

11. The system of claim 10, wherein the one or more circuits are configured to provide the selected technical sheet visually to the user of the system via the visual output device.

12. The system of claim 1, comprising an input component configured to receive input from the user of the system during the non-destructive testing (NDT) inspection.

13. The system of claim 12, wherein the one or more circuits are configured to select the technical sheet based on user input received via the input component.

14. The system of claim 12, wherein the one or more circuits are configured to handle user input received via the input component, the user input relating to the selected technical sheet and/or information provided via the selected technical sheet.

15. The system of claim 1, wherein the one or more circuits are configured to set one or more parameters associated with at least one of the one or more inspection components based on the selected technical sheet.

16. The system of claim 1, wherein the one or more inspection components are configured for performing magnetic particle inspection (MPI) based inspections.

17. The system of claim 1, wherein the one or more inspection components are configured for performing liquid penetrant inspection (LPI) based inspections.
